(19) United States
(12) Patent Application Publication
(10) Pub. No.: US 2007/0064150 A1
(43) Pub. Date: Mar. 22, 2007

(54) Signal processing apparatus and method for detecting information in a television broadcast

(75) Inventor: Joo-yoen Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/504,662

(22) Filed: Aug. 16, 2006

(30) Foreign Application Priority Data
Sep. 16, 2005 (KR) 2005-0086729

(51) Int. Cl. H04N 11/00

(52) U.S. Cl. 348/468

(57) ABSTRACT

The present invention relates to a signal processing apparatus, comprising a signal interface which receives a broadcasting signal comprising broadcasting data; a signal processor which generates a channel information guide (CIG) comprising channel information; and a controller which controls the signal processor to detect a state of the received broadcasting signal and to generate the channel information guide (CIG) based on state data of the broadcasting signal according to a detection result and the broadcasting data. Thus, the present invention provides a signal processing apparatus which provides a user with a channel information guide based on state data detected by itself, as well as broadcasting data included in a broadcasting signal, and a method for processing signal thereof.

### CROSS-REFERENCE TO RELATED APPLICATIONS

This application claims the benefit of Korean Patent Application No. 2005-0086729, filed on Sep. 16, 2005, in the Korean Intellectual Property Office, the disclosure of which is incorporated herein by reference.

### BACKGROUND OF THE INVENTION

1. Field of the Invention

The present invention relates to a signal processing apparatus and method, and more particularly, to a signal processing apparatus and method capable of processing a broadcasting signal comprising a video signal, an audio signal and broadcasting data received from an external source.

2. Description of the Related Art

Generally, terrestrial, cable and satellite broadcastings transmit broadcasting data with channel information, and a broadcasting signal having broadcasting data for information on a program provided by a corresponding channel, to a signal processing apparatus. Electronic program guide (EPG) information is an example of the broadcasting data.

The signal processing apparatus such as a TV or a set top box displays the broadcasting data on a channel information menu to be supplied to a viewer.

A conventional channel information menu is simply generated on the basis of the broadcasting data which is included in the broadcasting signal. Accordingly, the channel information menu supplied to a viewer by a conventional signal processing apparatus does not include information other than the broadcasting data generated by the external source such as a broadcasting station.

### SUMMARY OF THE INVENTION

Accordingly, it is an aspect of the present invention to provide a signal processing apparatus which provides a user with a channel information guide based on a detected state data of the channels, as well as broadcasting data included in a broadcasting signal, and a method for processing signal thereof.

Additional aspects and/or advantages of the present invention will be set forth in part in the description which follows and, in part, will be obvious from the description, or may be learned by practice of the present invention.

The foregoing and/or other aspects of the present invention are also achieved by providing a signal processing apparatus, comprising a signal interface which receives a broadcasting signal comprising broadcasting data; a signal processor which generates a channel information guide (CIG) comprising channel information; and a controller which controls the signal processor to detect a state of the received broadcasting signal and to generate the channel information guide (CIG) based on state data of the broadcasting signal according to a detection result and the broadcasting data.

According to another aspect of the present invention, the state of the broadcasting signal comprises at least one of a reception level of the broadcasting signal, a physical transmission channel (PTC), a modulation type, a broadcasting mode and resolution information.

According to another aspect of the present invention, the channel information comprises at least one of the reception level of the broadcasting signal, the physical transmission channel (PTC), the modulation type, the broadcasting mode, the resolution information, a program genre, a program title, viewing limitation information and time information.

According to another aspect of the present invention, the controller controls the signal interface to output the state data on the state of the broadcasting signal if it receives a predetermined request signal.

According to another aspect of the present invention, the signal processing apparatus further comprises a user selection part, wherein the controller controls the signal processor so that only information selected through the user selection part is included in the channel information.

According to another aspect of the present invention, the broadcasting data comprises a program and system information protocol (PSIP).

According to another aspect of the present invention, the signal processing apparatus further comprises a display part which displays the channel information guide thereon.

The foregoing and/or other aspects of the present invention are also achieved by providing a method for processing a signal, comprising receiving a broadcasting signal comprising broadcasting data; detecting a state of the broadcasting signal; and generating a channel information guide (CIG) comprising channel information based on state data according to a detection result and the broadcasting data.

According to another aspect of the present invention, the detecting the state of the broadcasting signal comprises determining at least one of a reception level of the broadcasting signal, a physical transmission channel (PTC), a modulation type, a broadcasting mode and resolution information.

According to another aspect of the present invention, generating the channel information guide comprises allowing the channel information to include at least one of the reception level of the broadcasting signal, the physical transmission channel, the modulation type, the broadcasting mode, the resolution information, a program genre, a program title, viewing limitation information and time information.

According to another aspect of the present invention, the method further comprises receiving a predetermined request signal which requests the state data; and outputting the state data on the state of the broadcasting signal based on the request signal.

According to another aspect of the present invention, the method further comprises providing a user selection part; selecting predetermined information through the user selection part; and allowing the channel information to include only the information selected through the user selection part.

According to another aspect of the present invention, the method further comprises displaying the channel information guide.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a signal processing apparatus according to an embodiment of the present invention;

FIG. 2 illustrates an example of a channel information guide according to the embodiment of the present invention; and

FIG. 3 is a control flowchart of the signal processing method according to an embodiment of the present invention.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout.

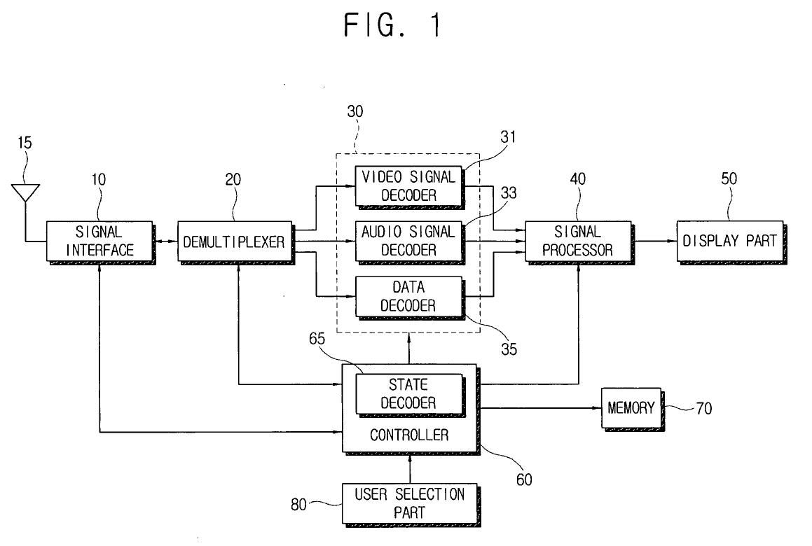

FIG. 1 is a control block diagram of a signal processing apparatus according to the present invention.

As shown therein, the signal processing apparatus according to the present invention comprises a signal interface 10 which receives a digital broadcasting signal; a signal processor 40 which processes the broadcasting signal received through the signal interface 10; and a controller 60 which controls the foregoing elements. The signal processing apparatus according to the present invention may further comprise a demultiplexer 20, a decoder 30, a user selection part 80 and a display part 50.

The digital broadcasting signal is transmitted as a transport stream for which a video signal, an audio signal and broadcasting data are time-division multiplexed and packetized.

The signal interface 10 receives the broadcasting signal comprising a video signal, an audio signal and broadcasting data, through an antenna 15. The signal interface 10 comprises a tuner (not shown) and a demodulator (not shown). Here, the broadcasting data comprises a program and system information protocol (PSIP) which has a system time table (STT), a master guide table (MGT), a rating region table (RRT), an event information table (EIT), an extended text table (ETT) and a virtual channel table (VCT).

The tuner tunes the received broadcasting signal into a broadcasting signal corresponding to a channel selected by a tuning control signal received from the controller 60 (to be described later). The demodulator demodulates and error-corrects the broadcasting signal of a certain channel tuned by the tuner to be transmitted as a transport stream.

The demultiplexer 20 divides the broadcasting signal received from the signal interface 10 into the video signal, the audio signal and the broadcasting data. The demultiplexer 20 outputs the video signal to a video signal decoder 31, the audio signal to an audio signal decoder 33, and the broadcasting data to a data decoder 35. Then, the video signal decoder 31, the audio signal decoder 33 and the data decoder 35 respectively decode the video and audio signals and the broadcasting data divided by the demultiplexer 20 to output them to the signal processor 40.

The signal processor 40 processes the broadcasting signal, i.e., the video and audio signals and the broadcasting data decoded by the decoder 30 to output them to the display part 50. Here, the signal processor 40 comprises a scaler which converts the broadcasting signal into a vertical frequency, resolution, a picture ratio to conform to output standards of the display part 50.

The signal processor 40 comprises an interface picture generator (not shown) which generates an interface picture comprising information with reorganized data based on the broadcasting data.

The display part 50 comprises a display module (not shown) which displays an image thereon, and a module driver (not shown) which processes the broadcasting signal input from the signal processor 40 to display an image on the display module. Here, the display module according to the present invention may comprise various display modules such as a digital light processing (DLP), a liquid crystal display (LCD) and a plasma display panel (PDP).

If the DLP is provided as the display module, the module driver may comprise an optical engine. If the LCD is provided as a display module, the module driver may comprise a printed circuit board (PCB) which converts the signal input from the signal processor 40 into a data signal and a gate signal. The display part 50 may comprise a module driver corresponding to types of the respective display modules.

The user selection part 80 is provided to input or select a predetermined function by a user. The user selection part 80 may be variously provided including a plurality of input keys, a button or a remote control.

The controller 60 controls the respective parts to display the broadcasting signal on the display part 50. The controller 60 may comprise a state detector 65 which detects a state of the broadcasting signal received through the signal interface 10. Accordingly, the controller 60 may detect the state of the broadcasting signal received through the signal interface 10.

For example, the controller 60 may determine the state of the broadcasting signal such as a reception level and types of the broadcasting signal by channel, and generate state data according to a determination result. The types of the broadcasting signal may comprise at least one of a physical transmission channel (PTC) corresponding to the respective channels, a modulation type of the respective channels (ex. 8VSB: Vestigial Side Band, 16VSB, 64QAM: Quardrature Amplitude Modulation), a broadcasting mode (ex. ATSC: Advanced Television System Committee, OCAP: Open Cable Application Platform) and resolution information. Here, the resolution information may be included in a sequence header of the broadcasting signal to be transmitted. The controller 60 may determine a resolution based on the resolution information of the sequence header.

The controller 60 reorganizes channel information based on the state data on the state of the broadcasting signal and the broadcasting data included in the broadcasting signal to generate a channel information guide (CIG), and controls the signal processor 40 to display the generated channel information guide on the display part 50 as the interface picture.

Here, the channel information may comprises the reception level of the broadcasting signal, the physical transmission channel (PTC), the modulation type, the resolution information, a program genre, a program title, viewing limitation information, a closed caption degree, time information, etc. The controller 60 may store the channel information in the memory 70.

The controller 60 may control the signal processor 40 to generate the channel information guide based on at least a part of the channel information stored in the memory 70, and to output it to the display part 50.

If at least a part of the channel information is selected through the user selection part 80, the controller 60 may control the signal processor 40 so that only the selected information is included in the channel information.

For example, if the display part 50 displays a list of the channel information selectable by a user thereon, the controller 60 may control the signal processor 40 so that only the information selected through the user selection part 80 among the channel information included in the list, is outputted to the display part 50 as the channel information guide. That is, the display part 50 displays the reception level of the broadcasting signal, the physical transmission channel, the modulation type, the resolution information, the program genre, the program title, the viewing limitation information, the closed caption degree, the time information, etc. as the list of the channel information. If the reception level of the broadcasting signal, the modulation type, the resolution information, the program genre are selected through the user selection part 80, the channel information guide may include only the reception level of the broadcasting signal, the modulation type, the resolution information and the program genre corresponding to respective channels. Furthermore, the CIG may comprise only of the detected state information and none of the broadcast information which is included in the broadcast signal.

Meanwhile, the controller 60 may cause the signal processing apparatus to transmit the state data to an external source, such as a broadcasting station or a cable company, in response to a request signal from the external source.

For example, if an external source requests the detected state data such as the reception level of the broadcasting signal, the signal processing apparatus may transmit the information on the reception level of the detected state data to the broadcasting station. Thus, the broadcasting station may determine the state of the broadcasting signal supplied to the signal processing apparatus and control the state of the broadcasting signal if the reception level of the broadcasting signal is lower than a predetermined level. The signal interface includes the two-way communication line and communication scheme utilized in cable or satellite set-top boxes (over wired telephone line, internet or wireless connection) or hotel LAN/servers to transmit or allow access of various kinds of state data detected by the signal processing apparatus.

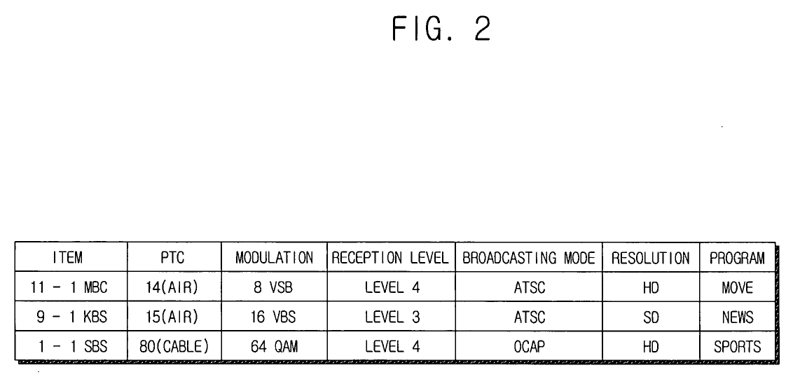

FIG. 2 illustrates an example of a channel information guide according to an embodiment of the present invention.

As shown therein, the channel information guide according to the present invention may comprise channel information (refer to “item” in FIG. 2) as a basic table based on respective channels.

Here, a reference channel is a virtual channel. The channel information comprises a physical transmission channel (PTC), a modulation type, a reception level, a broadcasting mode, resolution information and a program genre as an example of the present invention.

In the example of the FIG. 2, the virtual channel is 11-1 and the PTC is channel No. 14. The channel No. 14 is an air wave broadcasting (AIR), and the modulation type of the video signal corresponding to the channel 11-1 is 8VSB. The reception level of the video signal is Level 4, and the broadcasting mode is ATSC. The resolution information of the broadcasting signal is HD (high definition), and the program genre of the currently-supplied broadcasting signal is a movie. MBC is displayed as the broadcasting station corresponding to the virtual channel 11-1 in the channel item. MBC may be displayed in the channel information item as well. Even though 11-1 is displayed in the PTC as the air wave broadcasting, it may be provided as an additional item.

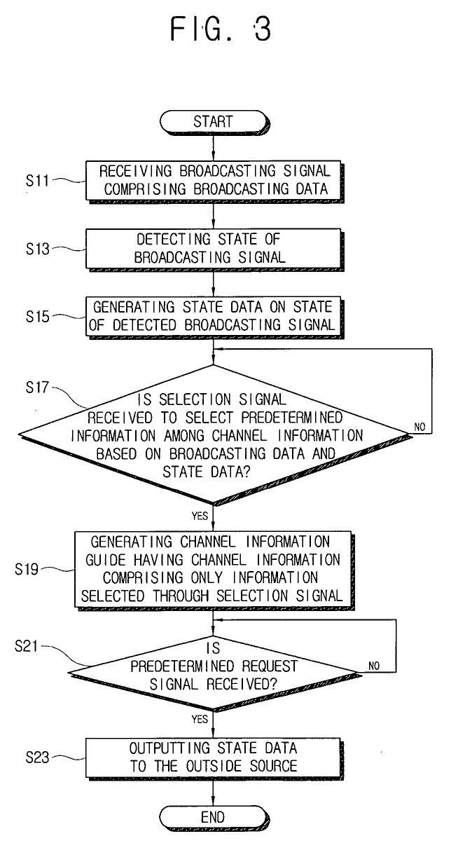

FIG. 3 illustrates a flowchart of a signal processing method according to the present invention.

As shown therein, the signal interface 10 provided in the signal processing apparatus according to the present invention receives a broadcasting signal comprising a video signal, an audio signal and broadcasting data at operation S11. The demultiplexer 20 divides the received broadcasting signal into the video and audio signals and the broadcasting data. Here, the controller 60 controls the tuner provided in the signal interface 10 to tune the respective channels and to receive the broadcasting signal corresponding to the respective channels if the signal processing apparatus is turned on or a predetermined condition is generated. The controller 60 detects the broadcasting data included in the respective broadcasting signals.

The state detector 65 detects the state of the received broadcasting signal at operation S13, and generates the state data based thereon at operation S15. The controller 60 may store the state data and the broadcasting data in the memory 70. At this time, the controller 60 may classify and store the respective channel information based on the state data and broadcasting data. The controller 60 may control the signal processor 40 to display the channel information set as a default, on the display part 50.

If the controller 60 receives a selection signal to select predetermined information among the channel information based on the broadcasting data and the state data stored in the memory 70 at operation S17, it may control the signal processor 40 to generate the channel information guide having the channel information including only information selected by the selection signal at operation S19. Then, a user may control the display part 50 to display the desired channel information only, corresponding to the respective channels.

Meanwhile, if the controller 60 receives a predetermined request signal to request the state data from the external source such as the broadcasting station at operation S21, the particular state data that is requested is outputted to the external source at operation S23.

In the signal processing apparatus according to the present invention, the display part 50 is provided in the signal processing apparatus, but not limited thereto. Alternatively, the display part 50 according to the present invention may be provided as an additional device.

For example, the signal processing apparatus according to the present invention may be implemented as a set-top box having no display. Alternatively, the signal processing apparatus according to the present invention may be implemented in devices having its own display such as a digital TV.

As described above, the signal processing apparatus according to the present invention provides not only the information supplied through the broadcasting data received from the external source, but also information supplied through the state data based on a detection of the received broadcasting signal, thereby supplying various kinds of information to the user. That is, the user conveniently becomes aware of the broadcasting state information, as well as the program information.

Also, the signal processing apparatus according to the present invention may transmit the state data stored in the memory 70 to the broadcasting station if such state data is desired to be known by the broadcasting station. Thus, the broadcasting station is able to recognize the broadcasting state through the state data and thus may be able to adjust the broadcasting signal.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A signal processing apparatus, comprising:
a signal interface which receives a broadcasting signal comprising broadcasting data;
a signal processor which generates a channel information guide (CIG) comprising channel information; and
a controller which controls the signal processor to detect a state of the received broadcasting signal and to generate the channel information guide (CIG) based on state data of the broadcasting signal according to a detection result and the broadcasting data.

2. The signal processing apparatus according to claim 1, wherein the state of the broadcasting signal comprises at least one of a reception level of the broadcasting signal, a physical transmission channel (PTC), a modulation type, a broadcasting mode and resolution information.

3. The signal processing apparatus according to claim 2, wherein the channel information comprises at least one of the reception level of the broadcasting signal, the physical transmission channel (PTC), the modulation type, the broadcasting mode, the resolution information, a program genre, a program title, viewing limitation information and time information.

4. The signal processing apparatus according to claim 3, wherein the controller controls the signal interface to output the state data on the state of the broadcasting signal to the outside if it receives a predetermined request signal to request the state data through the signal interface.

5. The signal processing apparatus according to claim 1, further comprising:
a user selection part, wherein
the controller controls the signal processor so that information selected only through the user selection part is included in the channel information.

6. The signal processing apparatus according to claim 1, wherein the broadcasting data comprises a program and system information protocol (PSIP).

7. The signal processing apparatus according to claim 6, further comprising a display part which displays the channel information guide thereon.

8. A method for processing a signal, comprising:
receiving a broadcasting signal comprising broadcasting data;
detecting a state of the broadcasting signal; and
generating a channel information guide (CIG) comprising channel information based on state data according to a detection result and the broadcasting data.

9. The method according to claim 8, wherein the detecting the state of the broadcasting signal comprises determining at least one of a reception level of the broadcasting signal, a physical transmission channel (PTC), a modulation type, a broadcasting mode and resolution information.

10. The method according to claim 9, wherein the generating the channel information guide comprises allowing the channel information to include at least one of the reception level of the broadcasting signal, the physical transmission channel, the modulation type, the broadcasting mode, the resolution information, a program genre, a program title, viewing limitation information and time information.

11. The method according to claim 10, further comprising:
receiving a predetermined request signal which requests the state data; and
outputting the state data on the state of the broadcasting signal to the outside based on the request signal.

12. The method according to claim 8, further comprising:
providing an user selection part;
selecting predetermined information through the user selection part; and
allowing the channel information to include information selected only through the user selection part.

13. The method according to claim 8, further comprising displaying the channel information guide.

14. A method for detecting state information of a broadcast television signal in a television receiver, comprising:
receiving a broadcast television signal characterized by a plurality of state information, the broadcast television signal also having broadcast information therein;
detecting the plurality of state information of the broadcast television signal; and
generating a channel information guide comprising at least of the detected plurality of state information of the broadcast television signal.

15. The method according to claim 14, further comprising the step of selecting by a user which one of said plurality of state information is included in said channel information guide.

16. The method according to claim 14, wherein said state information includes at least one of reception level, modulation type, broadcasting mode, video resolution or the physical transmission channel information.

17. The method according to claim 14, wherein the plurality of state information included in the channel information guide is a portion of the plurality of state information detected in the detecting step.

18. The method according to claim 14, wherein said channel information guide further includes broadcast information.

19. The method according to claim 18, wherein said broadcast information is a PSIP information.

20. The method according to claim 19, wherein said PSIP information included in the channel information guide is a program genre information.

21. The method according to claim 20, further comprising the step of transmitting the detected state information to a remote source.

22. The method according to claim 21, wherein the remote source is a television broadcast station.

23. The method according to claim 14, wherein the broadcast television signal is a satellite signal.

24. The method according to claim 14, wherein the broadcast television signal is a terrestrial signal.

25. The method according to claim 14, wherein said broadcast television signal is a cable signal.

26. The method according to claim 21, wherein said transmitting step comprises of using a telephone line to transmit the state information upon request from the remote source.

27. The method according to claim 21, wherein said transmitting step comprises of using an internet connection to transmit the state information upon request from the remote source.

28. The method according to claim 14, further comprising the step of displaying said channel information guide.

29. The method according to claim 14, wherein said channel information guide is generated as a two-dimensional guide having a plurality of channel number or name indications in the one dimension and a plurality of state information in an another dimension.

30. The method according to claim 29, wherein said channel information guide further includes at least one broadcast information corresponding to said channel number or name.
